(19) United States
(12) Patent Application Publication
(10) Pub. No.: US 2026/0359663 A1
(43) Pub. Date: Nov. 12, 2026

(54) Adaptive Large Language Model Architecture Based on System-on-Chip Temperature and Power

(71) Applicant: Google LLC, Mountain View, CA (US)

(72) Inventors: Mohsen Heidarinejad, San Jose, CA (US); Arpit Mittal, San Jose, CA (US); Arjang Shahriari, Sunnyvale, CA (US)

(73) Assignee: Google LLC, Mountain View, CA (US)

(21) Appl. No.: 19/205,481

(22) Filed: May 12, 2025

(51) Int. Cl. G06N 3/10

(52) U.S. Cl. CPC G06N 3/10

(57) ABSTRACT

Techniques and apparatuses are described for implementing an adaptive large language model (LLM) architecture based on a system-on-chip (SoC) temperature and power. In aspects, a decision module receives a hardware condition parameter and an LLM pipeline configuration (LPC) recommendation. In some examples, the decision module generates, based on the hardware condition parameter and the LPC recommendation, a reconfigured LPC. The decision module reconfigures the LLM pipeline based on the reconfigured LPC. In this way, the decision module can dynamically scale computational demands within an LLM pipeline, such as balancing temperature, power, and latency requirements, to make an informed LLM pipeline mitigation decision while maintaining a satisfactory user experience.

### BACKGROUND

Original equipment manufacturers (OEMs) of electronic devices often use a large language model (LLM) pipeline within an LLM architecture. Those OEMs face the challenge of dynamically mitigating system-on-chip (SoC) temperature values, power consumption levels, and latency. For example, a user may want to use an LLM on their computing device. To meet computational demands, the system may increase the performance of SoC components, such as a central processing unit (CPU) or a graphics processing unit (GPU). However, this may lead to significantly higher power consumption, which, in turn, generates excess heat/temperature. This may trigger thermal throttling, which introduces severe performance degradation, causing higher end-to-end LLM pipeline latency, input delays, and a poor user experience. A fixed LLM pipeline is also thermally inefficient because it ignores user query requirements and utilizes a full model pipeline at all times. Furthermore, the full model pipeline is inefficient on low-complexity user prompts and expedites SoC overheating, which may lead to severe performance implications.

### SUMMARY

Techniques and apparatuses are described for implementing an adaptive large language model (LLM) architecture based on a system-on-chip (SoC) temperature and power. In aspects, a decision module receives a hardware condition parameter and an LLM pipeline configuration (LPC) recommendation. In some examples, the decision module generates, based on the hardware condition parameter and the LPC recommendation, a reconfigured LPC. The decision module reconfigures the LLM pipeline based on the reconfigured LPC. In this way, the decision module can dynamically scale computational demands within an LLM pipeline, such as balancing temperature, power, and latency requirements, to make an informed LLM pipeline mitigation decision while maintaining a satisfactory user experience.

Aspects described below include a method performed by an SoC, the method including receiving, by a decision module, one or more hardware condition parameters. The method further includes receiving, by the decision module, one or more LLM pipeline configuration (LPC) recommendations. The method further includes generating, by the decision module and based on the one or more hardware condition parameters and the one or more LPC recommendations, a reconfigured LPC. The method further includes reconfiguring, based on the reconfigured LPC, the LLM pipeline.

Aspects described below also include an SoC including one or more processors, one or more process modules, and a memory storing instructions that, when accessed by the one or more processors, cause the one or more processors to perform any one of the described methods.

Aspects described below also include a non-transitory, computer-readable medium that, when accessed by one or more processors, causes the one or more processors to perform any one of the described methods.

Aspects described below also include a computer programming product that, when accessed by one or more processors, causes the one or more processors to perform any one of the described methods.

### BRIEF DESCRIPTION OF THE DRAWINGS

Apparatuses and techniques for implementing an adaptive LLM architecture based on SoC temperature and power are described with reference to the following drawings. The same numbers are used throughout the drawings to reference like features and components:

FIG. 1 illustrates an example environment in which an adaptive LLM architecture based on SoC temperature and power can be implemented;

FIG. 2 illustrates an example implementation of a computing device that can implement aspects of adaptive LLM architecture based on SoC temperature and power;

FIG. 3 illustrates an example implementation of adaptive LLM architecture based on SoC temperature and power;

FIG. 4 illustrates example modules for adaptive LLM architecture based on SoC temperature and power;

FIG. 5 illustrates an example implementation of adaptive LLM architecture based on SoC temperature and power;

FIG. 6 illustrates an example of training an LLM for an adaptive LLM architecture, as outlined in this disclosure;

FIG. 7 illustrates an example method for performing adaptive LLM architecture based on SoC temperature and power;

FIG. 8 illustrates another example method for adaptive LLM architecture based on SoC temperature and power;

FIG. 9 illustrates another example method for adaptive LLM architecture based on SoC temperature and power;

FIG. 10 illustrates another example method for adaptive LLM architecture based on SoC temperature and power;

FIG. 11 illustrates another example method for adaptive LLM architecture based on SoC temperature and power; and

FIG. 12 illustrates another example method for adaptive LLM architecture based on SoC temperature and power.

### DETAILED DESCRIPTION

An electronic device can be implemented with a system-on-chip (SoC), which can provide many features of the electronic device. An example SoC can include one or more SoC components. The one or more SoC components, for example, can include a central processing unit (CPU), a graphics processing unit (GPU), a tensor processing unit (TPU), a neural processing unit (NPU), an associative processing unit (APU), a field-programmable gate array (FPGA), a visual processing unit (VPU), a digital signal processor (DSP), a memory controller, a universal serial bus (USB) controller, a peripheral component interconnect express (PCIe) controller, an Ethernet controller, an Inter-Integrated Circuit (I2C) controller, a Serial Peripheral Interface (SPI) controller, a Direct Memory Access (DMA) controller, a WiFi™ controller, a Bluetooth™ controller, a hardware security module (HSM), a random number generator (RNG), an analog-to-digital converter (ADC), a digital-to-analog converter (DAC), a sensor, an audio processor, a video processor, a cryptographic accelerator, or an image sensor interface.

Original equipment manufacturers (OEMs) of electronic devices using such SoCs, including those with multi-core processors, face the challenge of dynamically mitigating system-on-chip (SoC) temperature values, power consumption levels, and latency. Consider a user of a computing device using the computing device for a video call while simultaneously using an LLM-based summarizer to convert meeting discussions into bullet points. The SoC of the computing device must handle video encoding/decoding, audio input/output, and the LLM's computation in parallel. The CPU and GPU load increase, causing the device to heat up. A fixed LLM pipeline continues to operate at full complexity, competing for thermal and power levels, thereby leading to video call stutters and lag in LLM responses, degrading user experience. An adaptive LLM pipeline based on SoC power and temperature is needed to maintain smooth system operation.

One or more process modules can be used to manage temperature, power, and latency conditions across one or more components within an SoC and an LLM pipeline. However, the one or more process modules may, in some examples, introduce unwanted conditions for a user. For example, the one or more process modules may attempt to optimize power efficiency in a manner that results in abrupt throttling of SoC components for thermal control. These sudden adjustments may negatively affect the user and their user experience. For example, one or more process modules may detect a rise in temperature and, in response, aggressively throttle the CPU and/or the GPU to mitigate overheating. However, this change in the LLM pipeline configuration may be excessively abrupt, causing a noticeable slowdown in the computing device. Such a slowdown can result in undesirable conditions, such as dropped video frames, input lag, and system stuttering, ultimately degrading the overall user experience.

The present document details the use of a decision module, which can enable selection between LLM pipeline configuration (LPC) recommendations. In the context of this document, the term LPC recommendations is defined as data configured to change LLM pipeline configuration. For example, if the SoC is determined to be operating at too high of a temperature, the LPC recommendation can include instructions to change a component of the LLM pipeline. The LPC recommendation can be configured to account for and/or affect any parameter of the SoC and the LLM pipeline, examples of which shall be illustrated further on in the document.

The decision module receives one or more LPC recommendations from the one or more process modules. The decision module, in aspects, generates a reconfigured LPC based on the received one or more LPC recommendations. In some examples, the reconfigured LPC is one of the one or more LPC recommendations. For example, the decision module can select one LPC recommendation by comparing the one or more LPC recommendations with one or more threshold values, or by comparing the one or more LPC recommendations to one another. For the purposes of this disclosure, such an operation of the decision module is implied directly or indirectly when reference is made to the SoC and/or LLM pipeline being influenced, controlled, or otherwise changed by the reconfigured LPC of the decision module.

### Operating Environment

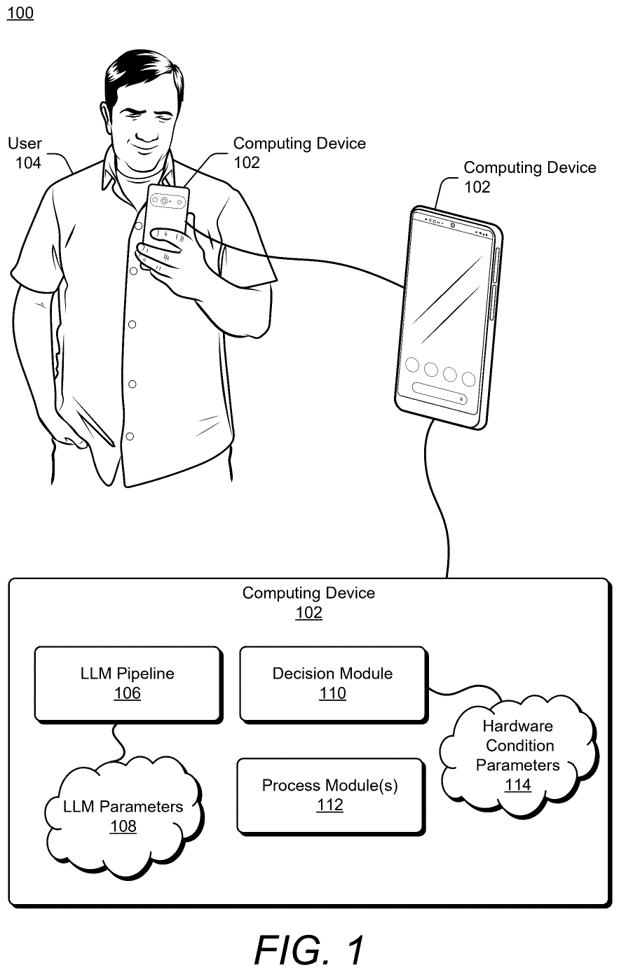

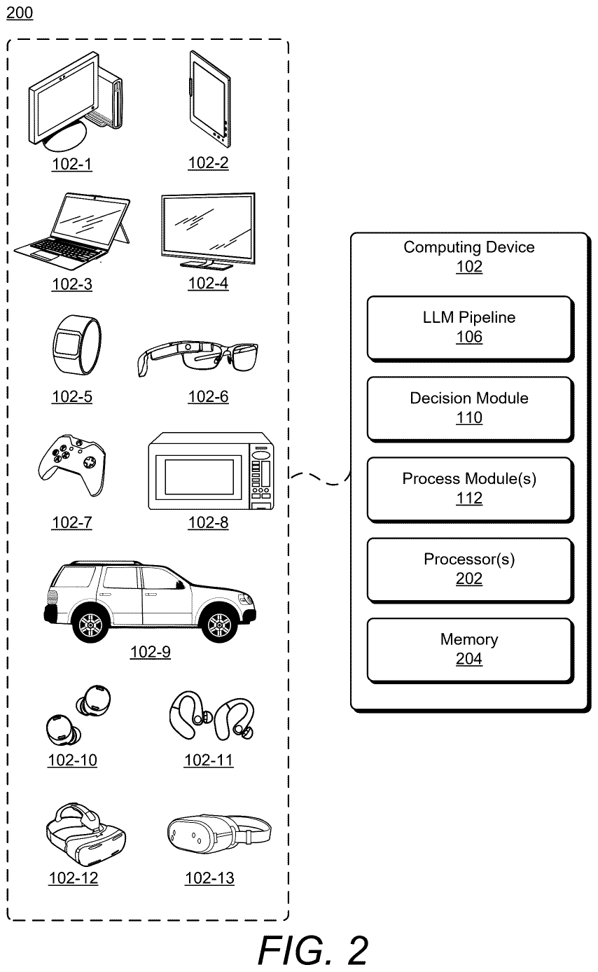

FIG. 1 illustrates an example environment 100 in which an adaptive LLM architecture based on SoC temperature and power can be implemented. In the example environment 100, a computing device 102 provides features and/or services for a user 104. Although depicted as a smartphone, the computing device 102 can include other types of devices, including those described with respect to FIG. 2. The computing device 102 includes an LLM pipeline 106. Examples of the LLM pipeline 106 (e.g., components of the LLM pipeline 106) can include one or more of an upper threshold for a number of matrix multiplications to be performed by an LLM, a model of the LLM, a token generation algorithm of the LLM, a low-rank adaptation (LoRA) selection, a number of layers of the LLM, an amount of access to a memory by the LLM, a frequency of one or more processors associated with the LLM, a voltage of the one or more processors associated with the LLM, or a number of cores of the one or more processors associated with the LLM.

The LLM pipeline 106, in aspects, includes LLM parameters 108. The LLM parameters 108 can affect a condition of the computing device 102, the LLM pipeline 106, or other related components. Examples of the LLM parameters 108 can include one or more of a latency of the LLM and a power consumption of the LLM. In some aspects, the LLM parameters 108 are an output of the LLM pipeline 106. The LLM pipeline components of the LLM pipeline 106 may affect the condition of the LLM parameters 108. For example, an LLM pipeline 106 that includes an upper threshold for a number of matrix multiplications to be performed by an LLM can include elements that affect latency and/or power consumption. These elements can include a maximum number of matrix operations per inference cycle, a floating-point operations per second (FLOPS) ceiling, an instruction-level cutoff, a truncation condition for attention layers, or a gating function that disables operations beyond a threshold.

In some examples, an LLM pipeline 106 that includes a model of the LLM can include elements that affect latency and/or power consumption. These elements can include a model type (e.g., decoder-only, encoder-decoder), a model size (e.g., 7B, 13B, 65B parameters), a model precision (e.g., 16-bit floating point (FP16), 8-bit integer (INT8)), a model quantization setting, or a pretraining domain. In other examples, the LLM pipeline 106 includes a token generation algorithm of the LLM, including elements that affect latency and/or power consumption. These elements can include a sampling strategy (e.g., greedy, top-k, top-p, beam search), a temperature value, a repetition penalty, a beam width, or a maximum token length. In further examples, the LLM pipeline 106 includes a LoRA selection, including elements that affect latency and/or power consumption. These elements can include an enabled state of LoRA modules, a disabled state of LoRA modules, a LoRA rank value, a LoRA scaling factor, a target layer designation, or a merge policy for based and adapted weights.

In examples, the LLM pipeline 106 includes a number of layers of the LLM, which can include elements that affect latency and/or power consumption. These elements can include a maximum layer depth, a minimum layer depth, an early-exit threshold, a skip-layer policy, or a dynamic pruning strategy. In some examples, the LLM pipeline 106 includes an amount of access to a memory by the LLM, which can include elements that affect latency and/or power consumption. These elements can include a memory bandwidth allocation, a memory pool assignment, a context length limit, a caching policy, or a swap strategy for off-chip storage. In other examples, the LLM pipeline 106 includes a frequency of one or more processors associated with the LLM, which can include elements that affect latency and/or power consumption. These elements can include a base clock rate, a turbo frequency threshold, a frequency scaling policy, a power-saving mode, or a workload-based clock adjustment profile. In further examples, the LLM pipeline 106 includes a voltage of one or more processors associated with the LLM, which can include elements that affect latency and/or power consumption. These elements can include a default voltage level, a voltage scaling policy, a thermal-based voltage limit, a minimum operating voltage, or a safe-operating-range indicator. In other examples, the LLM pipeline 106 includes a number of cores of one or more processors associated with the LLM, which can include elements that affect latency and/or power consumption. These elements can include a core allocation policy, a maximum thread count, a compute resource reservation, a parallelism setting (e.g., tensor parallelism, data parallelism, pipeline parallelism), or a core affinity mask.

The computing device 102 includes a decision module 110 and one or more process modules 112. The decision module 110 configures the LLM pipeline 106 based on the one or more process modules 112 and hardware condition parameters 114. For example, the hardware condition parameters 114 can include a temperature of an SoC, a power of the SoC, a temperature of an enclosure (e.g., the computing device 102), or a temperature of one or more processors. The SoC may include the one or more processors.

For example, the temperature of the SoC of the computing device 102 may be at too high of an operating temperature. The heat can contribute to increasing an internal temperature (e.g., an enclosure temperature) of the computing device 102. Left unchecked, the accumulation of heat within the computing device 102 can result in a high temperature that can damage the SoC, can damage other components (e.g., the one or more process modules 112) of the computing device 102, and/or can reduce a reliability of the computing device 102. The high temperature can cause the computing device 102 to become unsafe for the user 104 to operate.

To avoid these situations, the computing device 102 utilizes the decision module 110 to receive LLM pipeline configuration (LPC) recommendations from the one or more process modules 112. The decision module 110 receives information (e.g., temperatures, power status, predictions) from the hardware condition parameters 114 and other components of the computing device 102 to implement LLM pipeline throttling without significant performance degradation. For example, the decision module 110 can receive a current SoC temperature value, an SoC temperature prediction, and one or more LPC recommendations from the one or more process modules 112. Based on this information, the decision module 110 may determine that the LLM pipeline 106 needs a configuration that reduces computational intensity. For example, the decision module 110 may select an LPC recommendation that lowers token generation rates or switches to a smaller LLM model variant. This selection may enable continued operation of the LLM pipeline 106 while mitigating the risk of thermal throttling or system shutdown.

The decision module 110, in some examples, can choose whether or how to employ the one or more LPC recommendations from the one or more process modules 112. The process modules 112 can, for example, provide process module LPC recommendations to the decision module 110. The decision module 110 can select from the process module LPC recommendations to generate a reconfigured LPC or can generate the reconfigured LPC based on the process module LPC recommendations. Further still, the decision module 110 can modify the one or more process module LPC recommendations by comparing it to a threshold value for a temperature value, a power value, a latency value, a rate of change for operational optimization, user experience, or any other factor pertaining to smooth operation of the computing device 102.

The components of the computing device 102 (e.g., the LLM pipeline 106, the decision module 110, the one or more process modules 112) can alternatively be implemented within other types of integrated circuits or embedded systems, such as a microchip, an application-specific integrated circuit (ASIC), an application-specific standard product (ASSP), a digital signal processor (DSP), a programmable SoC (PSoC), a system-in-package (SiP), a controller, and so forth. The computing device 102 is further described with respect to FIG. 2.

### Example Computing Device

FIG. 2 illustrates an example implementation 200 of the computing device 102 of FIG. 1. The computing device 102 is illustrated with various non-limiting example devices, including a desktop computer 102-1, a tablet 102-2, a laptop 102-3, a television 102-4, a computing watch 102-5, computing glasses 102-6, a gaming system 102-7, a computing appliance 102-8, a vehicle 102-9, earbuds 102-10 (e.g., true-wireless earbuds, wired earbuds), hearing aids 102-11, a virtual-reality (VR) headset 102-12, and an augmented-reality (AR) headset 102-13. Other devices may also be used, including a home service device, a smart speaker, a smart thermostat, a baby monitor, a Wi-Fi™ router, a drone, a trackpad, a drawing pad, a netbook, an e-reader, a home automation and control system, a wall display, or another computing device. Note that the computing device 102 can be wearable, non-wearable but mobile, or relatively immobile (e.g., desktops and appliances). The computing device 102 includes the LLM pipeline 106, the decision module 110, and the one or more process modules 112 as described in FIG. 1.

The computing device 102 also includes at least one other processor 202 and at least one memory 204. The memory 204 can include memory media and/or non-transitory storage media. An operating system (not shown) embodied as computer-readable instructions on the memory 204 can be executed by the at least one other processor 202 and/or the LLM pipeline 106. In some examples, the decision module 110, at least one of the one or more process modules 112, or a combination of these reside on the memory 204.

### Dynamic Control for an LLM Architecture

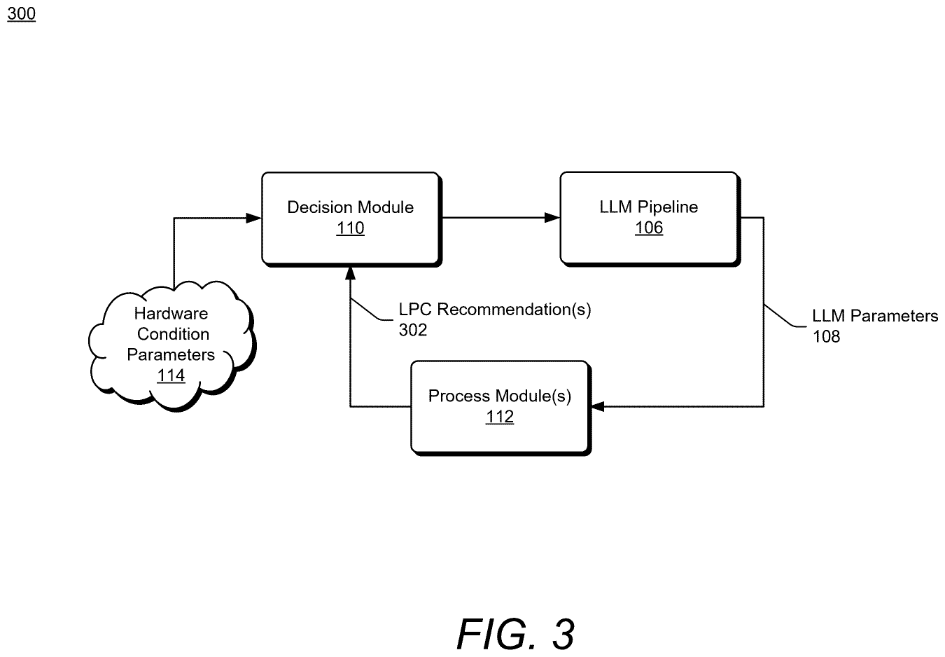

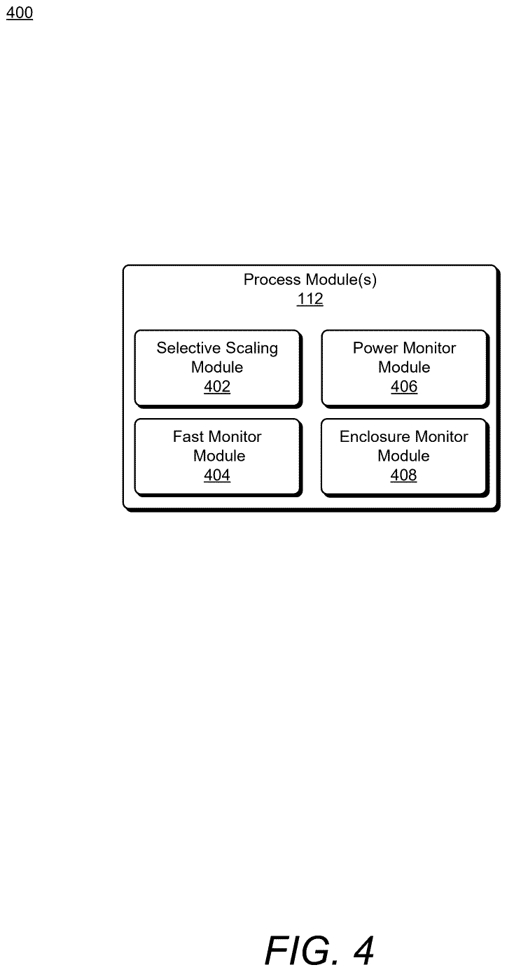

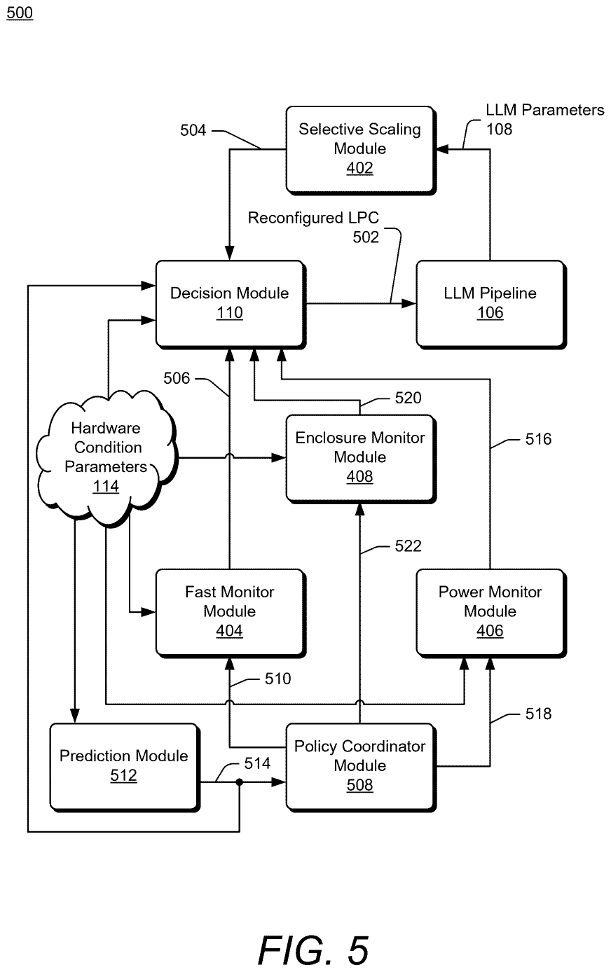

FIG. 3 illustrates an example implementation 300 of an adaptive LLM architecture. The decision module 110 (described with respect to FIG. 1) configures the LLM pipeline 106 based on the one or more process modules 112 and the hardware condition parameters 114. The LLM pipeline 106 outputs the LLM parameters 108 to the one or more process modules 112. The one or more process modules 112 output one or more LLM pipeline configuration (LPC) recommendations 302 to the decision module 110. Types of the one or more process modules 112 are further described with respect to FIG. 4. Further details of interactions, which include the one or more process modules 112, are described with respect to FIG. 5.

For example, a computing device (e.g., the computing device 102 of FIG. 1) may have a voice assistant application that a user (e.g., the user 104 of FIG. 1) may want to use. The LLM pipeline 106 of the computing device may be engaged to process a user query. A first process module of the one or more process modules 112 may determine that the computing device is operating on low power and may send a first process module LPC recommendation (e.g., one or more LPC recommendations 302) to the decision module 110 suggesting a reduced LLM complexity. A second process module of the one or more process modules 112 may determine that the SoC temperature of the computing device is rising and may send a second process module LPC recommendation to the decision module 110 suggesting a reduced number of active layers in the LLM pipeline 106. Based on these process module LPC recommendations (e.g., the one or more LPC recommendations 302), the decision module 110 can generate a reconfigured LPC that reduces the number of active layers and switches to a quantized version of the LLM with lower computational requirements. The reconfigured LPC then outputs modified LLM parameters 108 to the one or more process modules 112, thereby enabling the voice assistant application to continue functioning with minimal delay while preserving battery life and maintaining safe thermal conditions for the user.

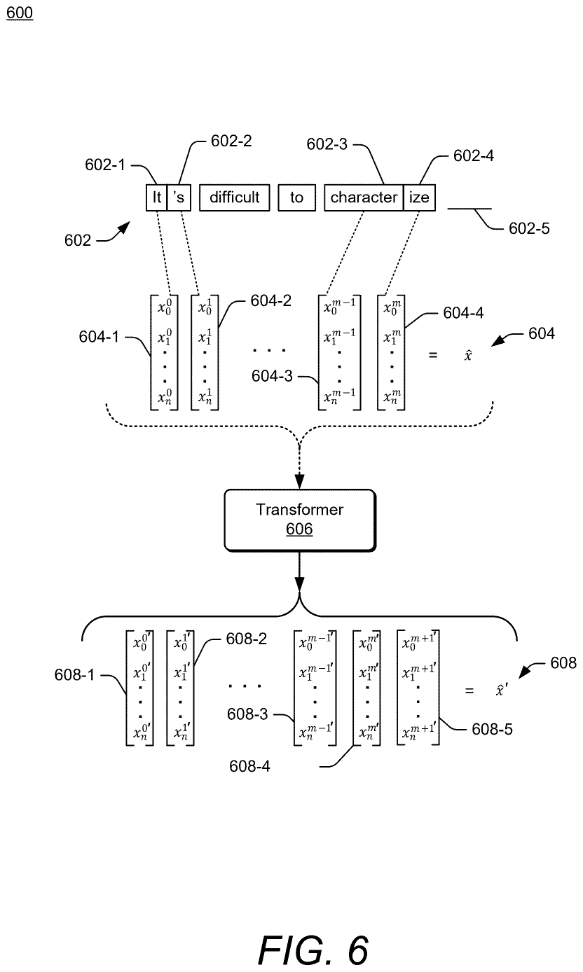

The outputs of the LLM pipeline 106, the decision module 110, and/or the one or more process modules 112 can be based on a machine-learned (ML) model. For example, the decision module 110 can include an ML model (e.g., an LLM, a neural-network, a multi-layer perceptron (MLP) model, a convolutional neural-network (CNN)) that takes the one or more LPC recommendations 302 and the hardware condition parameters 114 as inputs, providing the reconfigured LPC as an ML output. Other inputs can also be used by the ML model and/or to train the ML model, such as the LLM parameters 108, one or more threshold values, one or more policies, etc. Additional aspects relating to ML are described with respect to FIG. 6.

FIG. 4 illustrates example process modules 112 for an adaptive LLM architecture in an example implementation 400. A selective scaling module 402 may receive one or more LLM parameters 108 of FIG. 1 from the LLM pipeline 106 of FIG. 1. The selective scaling module 402 may generate a scaling LPC recommendation based on the one or more LLM parameters 108. In this example, the one or more LLM parameters 108 can be a latency of an LLM and a power consumption of the LLM. The selective scaling module 402 can enforce adjustments to the LLM pipeline 106 based on the one or more LLM parameters 108. For example, the selective scaling module 402 can perform an online detailed power consumption analysis or an online detailed latency analysis of individual LLM pipeline components to ensure mitigations to the LLM pipeline 106 are enforced based on efficiency. In another example, the selective scaling module 402 can perform a selective downscale of an LLM pipeline component if the LLM pipeline component uses significant power without significantly improving latency compared to the rest of the LLM pipeline components.

For example, a computing device (e.g., the computing device 102 of FIG. 1) includes an LLM, an LLM pipeline (e.g., the LLM pipeline 106 of FIG. 1), components of an LLM pipeline, and one or more LLM parameters (e.g., the one or more LLM parameters 108 of FIG. 1). An LLM pipeline component can be a token generation algorithm of the LLM. The selective scaling module 402 can evaluate the one or more LLM parameters (e.g., power consumption, latency) of the computing device and can determine that the current token generation configuration is not working efficiently. The selective scaling module 402 can generate a scaling LPC recommendation to adjust the token generation configuration to greedy decoding. A decision module (e.g., the decision module 110 of FIG. 1) can receive the scaling LPC recommendation from the selective scaling module 402 and can generate a reconfigured LPC to reconfigure the LLM pipeline. The decision module can reconfigure the token generation configuration so that the token generation latency is reduced and/or the power consumption is reduced.

A fast monitor module 404 may receive one or more hardware condition parameters (e.g., the hardware condition parameters 114 of FIG. 1). The one or more hardware condition parameters can be a temperature of an SoC. The fast monitor module 404 may compare the temperature of the SoC with an SoC temperature threshold. The fast monitor module 404 may generate a fast monitor LPC recommendation based on the comparison of the temperature of the SoC to the SoC temperature threshold. The fast monitor LPC recommendation may be configured to reduce a pipeline prefix length of the LLM pipeline 106, reduce a number of transformer layers of the LLM pipeline 106, set an upper threshold for a number of matrix multiplications to be performed by the LLM, reduce a numerical precision of the LLM, select a LoRA for the LLM pipeline 106, or change an LLM model of the LLM pipeline 106. In further examples, the fast monitor module 404 may operate based on a reduced order model when the SoC temperature is critically high.

For example, a computing device may include an SoC and an instantaneous SoC temperature. The fast monitor module 404 may determine that the SoC temperature exceeds a predefined SoC temperature threshold and may generate a fast monitor LPC recommendation to send to a decision module (e.g., the decision module 110 of FIG. 1). The fast monitor LPC recommendation may be an LPC recommendation to gradually reduce the LLM pipeline 106 prefix length by truncating the prompt history from 2048 tokens to 1024 tokens. The reduced prefix length may mitigate heat buildup by lowering the computational demand. The fast monitor module 404 may generate a fast monitor LPC recommendation to reduce a number of transformer layers from 32 transformer layers to 24 layers which reduces the number of computations needed for each token during interference and subsequently lowers SoC power consumption and the instantaneous SoC temperature. Further still, the fast monitor module 404 may monitor SoC temperature and, upon detecting the SoC temperature exceeding the SoC temperature threshold, may generate a fast monitor LPC recommendation to select a more efficient LoRA. For example, if the current LoRA involves dense projection matrices, the fast monitor LPC recommendation is a recommendation to switch to a LoRA configuration with reduced rank and parameter size. The new LoRA configuration may enable task-specific adaptation with minimal impact on the computing device and may decrease the SoC temperature.

A power monitor module 406 may receive the one or more hardware condition parameters. The one or more hardware condition parameters can be a power or power consumption of an SoC. The power monitor module 406 may compare the power of the SoC with an SoC power threshold. The power monitor module 406 may generate a power LPC recommendation based on the comparison of the power of the SoC to the SoC power threshold. The power LPC recommendation may be configured to disable a number of feedforward layers of the LLM pipeline 106, remove a subset of a context data from a cache of the LLM pipeline 106, or select a token generation algorithm from a plurality of token generation algorithms of the LLM pipeline 106. In some examples, the power monitor module 406 can monitor the SoC power through capturing SoC power consumption trends. A lowpass filter with a tunable time constant can be used to capture the SoC power consumption trends. Through monitoring the deviation of the SoC power consumption trends from the SoC power consumption threshold, the power monitor module 406 may generate a power LPC recommendation configured to reduce dense matrix multiplications, mitigate memory usage bandwidth, or increase response generation speed.

For example, a computing device includes the SoC and a power of the SoC. The power monitor module 406 may determine that the SoC power exceeds a predefined SoC power threshold and may generate a power LPC recommendation to send to the decision module. The power monitor module 406 may determine that a high-complexity token generation algorithm (e.g., beam search, temperature-controlled sampling) contributes to excess SoC power consumption and may generate a power LPC recommendation to switch to a different token generation algorithm. The power monitor module 406 may suggest a transition to nucleus sampling with a reduced sampling window to lower sampling operations and simplify branching logic, thereby decreasing overall power requirements of the SoC and the computing device.

An enclosure monitor module 408 may receive the one or more hardware condition parameters. The one or more hardware condition parameters can be a temperature of an enclosure. The enclosure may house at least the LLM pipeline 106. The enclosure monitor module 408 may compare the temperature of the enclosure with an enclosure temperature threshold. The enclosure monitor module 408 may generate an enclosure LPC recommendation based on the comparison of the temperature of the enclosure to the enclosure temperature threshold. The enclosure LPC recommendation may be configured to select an LLM model of the LLM pipeline 106, direct a workload to a processor of a plurality of processors (e.g., at least one processor 202 of FIG. 2) of the LLM pipeline 106, or reduce a pipeline prefix length of the LLM pipeline 106. The enclosure monitor module 408 may ensure that the enclosure temperature does not reach an uncomfortable level for a user (e.g., the user 104 of FIG. 1). Relative to the fast monitor module 404 and the power monitor module 406, the enclosure monitor module 408 may operate at a lower cadence due to the slower dynamics of the enclosure temperature, thereby allowing enclosure temperature control without sudden regression in performance. In some examples, the enclosure monitor module 408 prioritizes SoC energy efficiency over LLM performance metrics and limits SoC power consumption through the enclosure LPC recommendations.

For example, a computing device includes the LLM pipeline 106, an enclosure housing at least the LLM pipeline 106, and an enclosure temperature. The enclosure monitor module 408 may determine that the enclosure temperature exceeds a predefined enclosure temperature threshold and may generate an enclosure LPC recommendation to send to the decision module. The enclosure monitor module 408 may determine that the enclosure temperature exceeds an enclosure temperature threshold of 39 °C because one processor of a plurality of processors of the LLM pipeline 106 has a disproportionate power and thermal contribution. Based on this determination, the enclosure monitor module 408 may generate an enclosure LPC recommendation to reassign the LLM workloads to a different processor of the plurality of processors of the LLM pipeline 106. The different processor may have a lower recent power consumption profile or better thermal dissipation characteristics. More specifically, inference execution may be migrated from a high-performance core cluster to an energy-efficient cluster or a dedicated neural processing unit (NPU) thereby helping to spatially distribute heat across the enclosure, which, in turn, maintains safe temperatures for users.

FIG. 5 illustrates an example implementation 500 of an adaptive LLM architecture. The decision module 110 of FIG. 1 receives one or more LPC recommendations (e.g., the one or more LPC recommendations 302 of FIG. 3) from one or more process modules (e.g., the one or more process modules 112 of FIG. 1). Based on one or more LPC recommendations and the hardware condition parameters 114 of FIG. 1, the decision module 110 provides a reconfigured LPC 502 to the LLM pipeline 106 of FIG. 1.

In aspects, the LLM pipeline 106 outputs the LLM parameters 108 to the selective scaling module 402 of FIG. 4. Based on the LLM parameters 108 (e.g., power consumption and latency requirements of the LLM pipeline 106 and LLM pipeline components), the selective scaling module 402 can output a scaling LPC recommendation 504 to the decision module 110. The selective scaling module 402 can perform a detailed power and latency analysis of the LLM pipeline 106 and the LLM pipeline components to ensure that pipeline mitigations are enforced based on efficiency while also minimizing potential user experience downgrades. The selective scaling module 402 can perform a selective downscale of an LLM pipeline component (e.g., a token generation algorithm, a LoRA selection) if the LLM pipeline component has a significant SoC (e.g., at least one processor 202 of FIG. 2) power consumption level but a low latency improvement level compared to other LLM pipeline components.

In other aspects, the fast monitor module 404 of FIG. 4 outputs a fast monitor LPC recommendation 506 to the decision module 110. In some examples, the fast monitor module 404 receives the hardware condition parameters 114 and, based on the hardware condition parameters 114 (e.g., a temperature of an SoC), determines the fast monitor LPC recommendation 506. The fast monitor LPC recommendation 506 can be an adjustment to a pipeline prefix length of the LLM pipeline 106.

A policy coordinator module 508 can provide temperature and power consumption thresholds for the one or more process modules 112. The policy coordinator module 508 may output an SoC temperature threshold 510 to the fast monitor module 404. The fast monitor module 404 can compare the SoC temperature threshold 510 to the hardware condition parameters (e.g., the temperature of the SoC) and, based on this comparison, can output the fast monitor LPC recommendation 506 to the decision module 110. A prediction module 512 can output prediction recommendations 514 to the policy coordinator module 508. The policy coordinator module 508, in examples, determines current thermal and/or power limits of the system (e.g., the computing device 102 of FIG. 1) and outputs those as thresholds to the one or more process modules 112. In other examples, the prediction module 512 receives the hardware condition parameters 114 (e.g., the temperature of the SoC, a power consumption of the SoC, or a temperature of an enclosure) and, based on the hardware condition parameters 114, predicts future temperatures of the SoC and enclosure or future power consumption levels of the SoC. The prediction module 512 can output the prediction recommendations 514 to the decision module 110. The decision module 110 can output the reconfigured LPC 502 to the LLM pipeline 106 based on the prediction recommendations 514. The prediction module 512 may be a machine-learned model. In some examples, the prediction module 512 includes an ML model.

In aspects, the power monitor module 406 of FIG. 4 outputs a power LPC recommendation 516 to the decision module 110. The power monitor module 406 can receive an SoC power threshold 518 from the policy coordinator module 508. The power monitor module 406 can also receive hardware condition parameters 114 (e.g., power consumption of an SoC) and, based on a comparison of the hardware condition parameters 114 and the SoC power threshold 518, can determine the power LPC recommendation 516.

In aspects, the enclosure monitor module 408 of FIG. 4 outputs an enclosure LPC recommendation 520 to the decision module 110. The enclosure monitor module 408 can receive an enclosure temperature threshold 522 from the policy coordinator module 508. The enclosure monitor module 408 can also receive the hardware condition parameters 114 (e.g., temperature of the enclosure) and, based on a comparison of the hardware condition parameters 114 and the enclosure temperature threshold 522, can determine the enclosure LPC recommendation 520.

In aspects, the prediction module 512 indirectly enforces LLM pipeline mitigation by altering the SoC temperature threshold 510, the SoC power threshold 518, and the enclosure temperature threshold 522 to ensure a smooth transition between different LLM pipeline configurations. The prediction module 512 can avoid unnecessary or excessive LLM pipeline mitigation when the prediction recommendations 514 indicate that the system has enough thermal headroom. Multiple output possibilities indicated in FIG. 5 from a single module of the one or more process modules 112 can be output along any one or more of the possible output paths. In some examples, fewer than all of the one or more process modules 112 provide an output to the decision module 110. In some examples, at least one of the one or more process modules 112 provides multiple outputs to the decision module 110. Various alternate and/or combination pathways not pictured for clarity can be equally employed.

### Large Language Models

Generally, LLMs are a class of artificial intelligence (AI). LLMs (e.g., GPT, LLaMA, Claude, Mistral) are trained on enormous amounts of data to provide foundational capabilities, which can be used and reused, often through fine-tuning for particular applications and tasks. Other software applications, in contrast, are often built and trained on specific data for each use case. In this way, LLMs are considered a type of foundational model.

Some LLMs use an ML model that can parse language and provide context-aware outputs, for example to mimic a human response. This mimicry of a human response is typically to a prompt, for example from a user asking a question. The prompt “ask how to get to the train station in French,” for example, can be used as a prompt by which an LLM provides a translation service, for example a response in the French language to the English language prompt. An ML model, as discussed in this disclosure, refers to a computer model that has been trained using one or more machine-learning techniques. In general, this training may be done by providing training inputs to one or more training models, which in turn may provide an output. The output may be in the form of a prediction, a confidence score, or another probability-based output.

By way of example, consider FIG. 6, which illustrates a trainer 600 by which to train an LLM used for an adaptive LLM architecture. The trainer 600 receives training data as training inputs, such as an input 602. This training data may be of many different types, such as text from publicly available websites, encyclopedias, online forums, social media platforms, news articles, blogs, books, academic papers, legal documents, medical literature, scientific publications, product manuals, software documentation, structured data tables, spreadsheets, databases, configuration files, user-generated content, and subtitles or transcripts from videos. In the example illustrated by FIG. 6, the training input 602 is a phrase, though it may instead be a word, a long text passage (e.g., a book, article, or web-page), or any other data containing comprehensible text. In some examples, the text is from a screen or image capture. In a process called “tokenization,” the trainer 600 breaks the training input 602 into tokens, marked as tokens 602-1, 602-2, 602-3, and 602-4. Here the training input 602 has a missing next word, marked as a blank 602-5. The goal of the trainer 600 is to predict the blank 602-5.

The trainer 600 encodes the tokens (602-1, 602-2, etc.) into an input tensor \hat{x} 604 through a mapping procedure. For instance, the token “It” 602-1 is mapped to a first component 604-1 of the input tensor \hat{x} 604, the token “'s” is mapped to a second component 604-2 of the input tensor \hat{x} 604, the token “character” is mapped to a third component 604-3 of the input tensor \hat{x} 604, and the token “ize” is mapped to a fourth component 604-4 of the input tensor \hat{x} 604. Though the tokens “It” 604-1 and “'s” 604-2 are shown as two portions of the word “It's,” other mapping schemes exist, for example a mapping based on discrete words or phonemes. In some instances, an ML model or an ML component of the trainer 600 performs the tokenization and/or mapping of the training input 602 into the input tensor \hat{x} 604 (e.g., a feature-extracting CNN). The mapping of the tokenized training input 602 into the input tensor \hat{x} 604 may involve a lookup table, which maps each possible token (e.g., 602-1, 602-2, etc.) to a known tensor object in a language space of the training data.

A transformer 606 takes the input tensor \hat{x} 604 as an input, with the goal of predicting the blank 602-5 by transforming the input tensor \hat{x} 604 into a transformed tensor \hat{x}′ 608. The transformation process is mathematically represented as follows:

T\hat{x}=\hat{x}′ Eq. 1

T in Eq. 1 represents the transformer 606. The transformed tensor \hat{x}′ 608 includes components 608-1, 608-2, 608-3, 1208-4, and 608-5. The component 608-1 is a transformation of the component 604-1 by the transformer 606 (similar for component pairs 608-2/604-2, 608-3/604-3, and 608-4/604-4). The component 608-5 corresponds to the blank 602-5, and thus the component 608-5 is a prediction for the blank 604-5. The final transformed tensor \hat{x}′ 608 component 608-5 is derived as part of the transformation process in addition to the contextualization of the components 604-1 through 604-4.

Inputs, e.g., the input tensor \hat{x} 604 and/or the training input 602, generally include multiple tokens. For instance, the training input 602 includes the tokens 602-1 through 602-4. The trainer 600 converts a single training input (e.g., the training input 602) into multiple training inputs. For example, by removing the token 602-4, the blank 602-5 shifts left as the training input 602 calls for the trainer 600 to predict the token 602-4, thus creating a new training input from the original training input 602. As the value for the token 602-4 is known in this example, the new input is a labeled input, which allows it to be used by a supervised ML training algorithm (it should be noted that such an input is also able to be used by an unsupervised ML training algorithm). In this way, a single text containing multiple tokens (e.g., a book, a research paper, etc.) is used as multiple training inputs for the trainer 600.

It will be understood by a person of ordinary skill in the art that the aforementioned are merely examples of the types of machine-learning training that may be used to produce an ML model or an LLM for any aspect of an adaptive LLM architecture based on SoC temperature and power. Other combinations and techniques may be employed, which do not alter the scope of the inventive concept of an adaptive LLM architecture based on SoC temperature and power. Examples such as employing a CNN, use of the LLM parameters 108 of FIG. 1 as inputs, use of the hardware condition parameters 114 as inputs, including a fully connected portion of the machine learning training, etc. are not meant to be limiting but to serve as examples of how an LLM for generating reconfigured LLM pipeline configurations may be accomplished.

### Example Methods

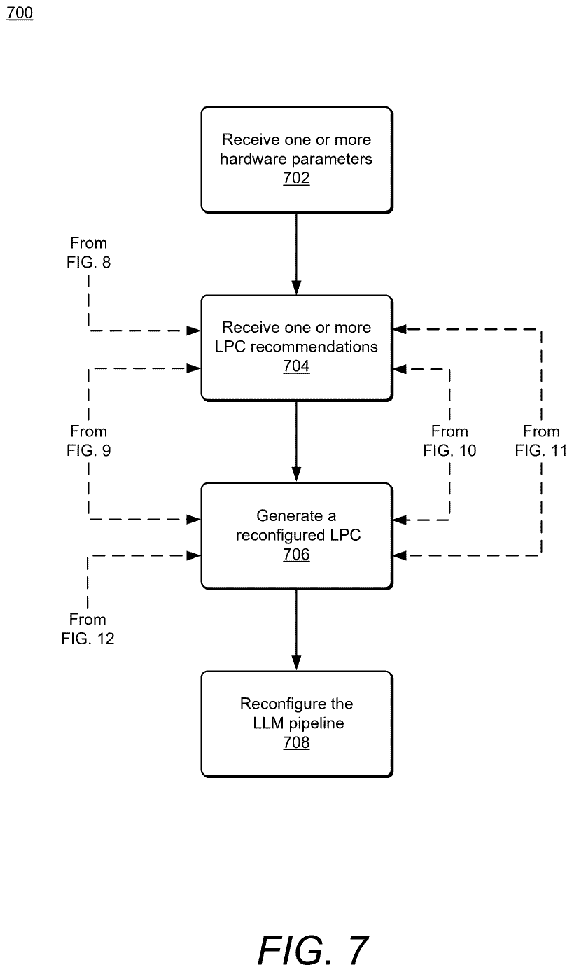

FIGS. 7, 8, 9, 10, 11, and 12 depict example methods 700, 800, 900, 1000, 1100, and 1200 for implementing aspects of an adaptive LLM architecture based on SoC temperatures and power consumption levels. The methods 700, 800, 900, 1000, 1100, and 1200 are shown as a set of operations (or acts) performed but not necessarily limited to the order or combinations in which the operations are shown herein. Further, any of one or more of the operations may be repeated, combined, reorganized, or linked to provide a wide array of additional and/or alternate methods. In portions of the following discussion, reference may be made to the environment 100 of FIG. 1 and entities detailed in FIGS. 1-6, reference to which is made for example only. The techniques are not limited to performance by one entity or multiple entities operating on one device.

FIG. 7 illustrates the example method 700 for configuring an LLM pipeline (e.g., the LLM pipeline 106 of FIG. 1). At 702, one or more hardware condition parameters (e.g., the hardware condition parameters 114 of FIG. 1) are received by a decision module (e.g., the decision module 110 of FIG. 1). The one or more hardware condition parameters may include a temperature of an SoC, a power of the SoC, and a temperature of an enclosure. At 704, one or more LLM pipeline configuration (LPC) recommendations (e.g., the one or more LPC recommendations 302 of FIG. 3) are received by the decision module. The one or more LPC recommendations may be generated by one or more process modules (e.g., the one or more process modules 112 of FIG. 1). The one or more process modules may include a selective scaling module (e.g., the selective scaling module 402 of FIG. 4), a fast monitor module (e.g., the fast monitor module 404 of FIG. 4), a power monitor module (e.g., the power monitor module 406 of FIG. 4), and an enclosure monitor module (e.g., the enclosure monitor module 408 of FIG. 4).

At 706, a reconfigured LPC (e.g., the reconfigured LPC 502 of FIG. 5) is generated by the decision module. In some examples, the decision module generates the reconfigured LPC based on the one or more hardware condition parameters and the one or more LPC recommendations. At 708, the LLM pipeline is reconfigured. In some examples, the LLM pipeline is reconfigured based on the reconfigured LPC. The LLM pipeline can include one or more of the following LLM pipeline components: an upper threshold for a number of matrix multiplications to be performed by the LLM, a model of the LLM, a token generation algorithm of the LLM, a prefix length for an input (e.g., the training input 602 of FIG. 6) of the LLM, a LoRA selection, a number of layers of the LLM, an amount of access to a memory (e.g., the memory 204 of FIG. 2) by the LLM, a frequency of one or more processors (e.g., the at least one processor 202 of FIG. 2) associated with the LLM, a voltage of the one or more processors associated with the LLM, or a number of cores of the one or more processors associated with the LLM.

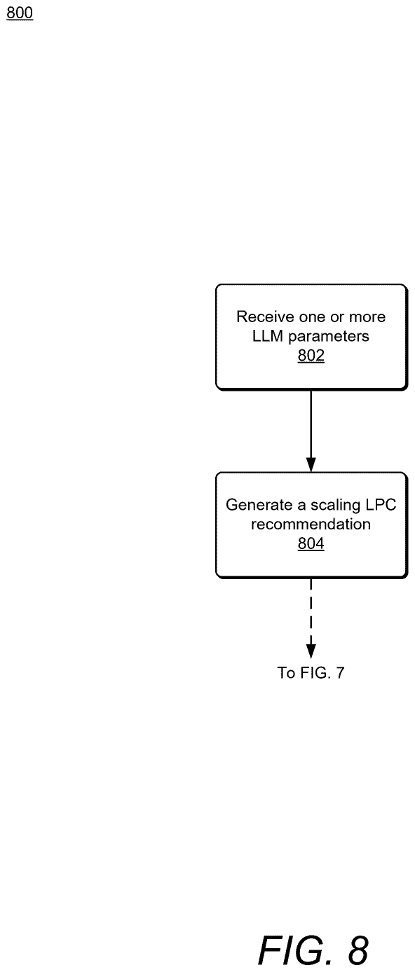

FIG. 8 illustrates the example method 800 for configuring an LLM pipeline (e.g., the LLM pipeline 106 of FIG. 1). The method 800 includes the method 700. At 802, one or more LLM parameters (e.g., the LLM parameters 108 of FIG. 1) are received by a selective scaling module (e.g., the selective scaling module 402 of FIG. 4). The one or more LLM parameters may include one or more of a latency of the LLM and a power consumption of the LLM. At 804, a scaling LPC recommendation (e.g., the scaling LPC recommendation 504 of FIG. 5) is generated by the selective scaling module. The selective scaling module may generate the scaling LPC recommendation based on the one or more LLM parameters, and the one or more LPC recommendations (e.g., the one or more LPC recommendations 302 of FIG. 3) may include the scaling LPC recommendation.

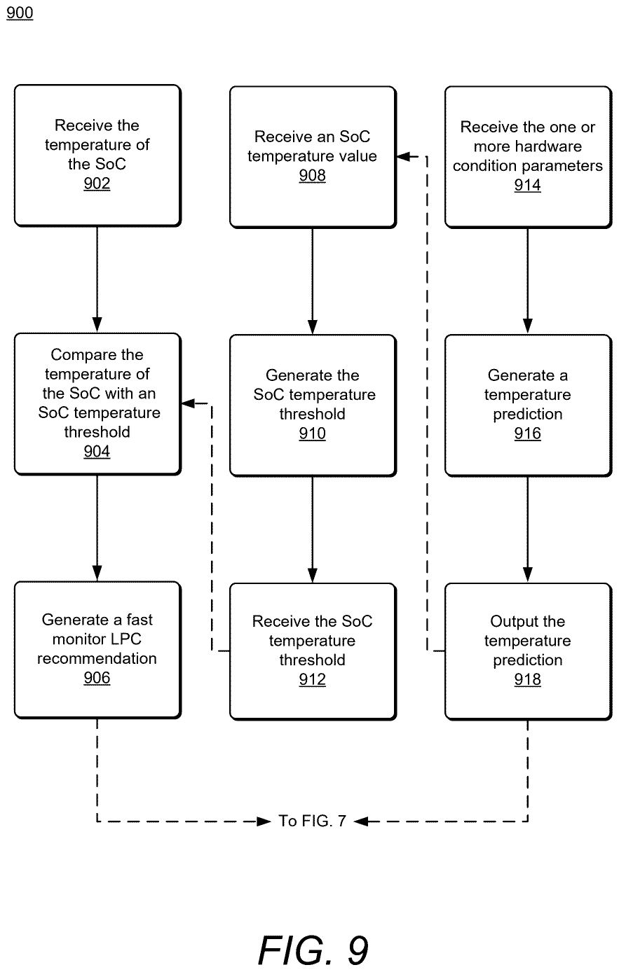

FIG. 9 illustrates the example method 900 for configuring an LLM pipeline (e.g., the LLM pipeline 106 of FIG. 1). The method 900 includes the method 700. At 902, the temperature of the SoC (e.g., the hardware condition parameters 114 of FIG. 1) is received by the fast monitor module (e.g., the fast monitor module 404 of FIG. 4). In aspects, the temperature of the SoC is also a temperature of a processor (e.g., the at least one processor 202 of FIG. 2). At 904, the temperature of the SoC is compared with an SoC temperature threshold (e.g., the SoC temperature threshold 510 of FIG. 5) by the fast monitor module. The SoC temperature threshold may also be a processor temperature threshold. At 906, a fast monitor LPC recommendation (e.g., the fast monitor LPC recommendation 506 of FIG. 5) is generated by the fast monitor module. The fast monitor module may generate the fast monitor LPC recommendation based on the comparison of the temperature of the SoC to the SoC temperature threshold, and the one or more LPC recommendations (e.g., the one or more LPC recommendations 302 of FIG. 3) may include the fast monitor LPC recommendation. In some examples, the fast monitor LPC recommendation is configured to reduce a pipeline prefix length of the LLM pipeline, reduce a number of transformer layers of the LLM pipeline, set an upper threshold for a number of matrix multiplications to be performed by the LLM, reduce a numerical precision of the LLM, select a LoRA for the LLM pipeline, or change an LLM model of the LLM pipeline.

At 908, an SoC temperature value is received by a policy coordinator module (e.g., the policy coordinator module 508 of FIG. 5). The SoC temperature value may be based on the temperature of the SoC. In some examples, the SoC temperature value is also a processor temperature value. At 910, the SoC temperature threshold is generated by the policy coordinator module. At 912, the SoC temperature threshold is received by the fast monitor module.

At 914, the one or more hardware condition parameters is received by a prediction module (e.g., the prediction module 512 of FIG. 5). The prediction module may be an ML model. At 916, a temperature prediction (e.g., the prediction recommendations 514 of FIG. 5) is generated by the prediction module. At 918, the temperature prediction is output to the policy coordinator module and to the decision module (e.g., the decision module 110 of FIG. 1). The SoC temperature value may include the temperature prediction, and the reconfigured LPC (e.g., the reconfigured LPC 502 of FIG. 5) may be based on the temperature prediction.

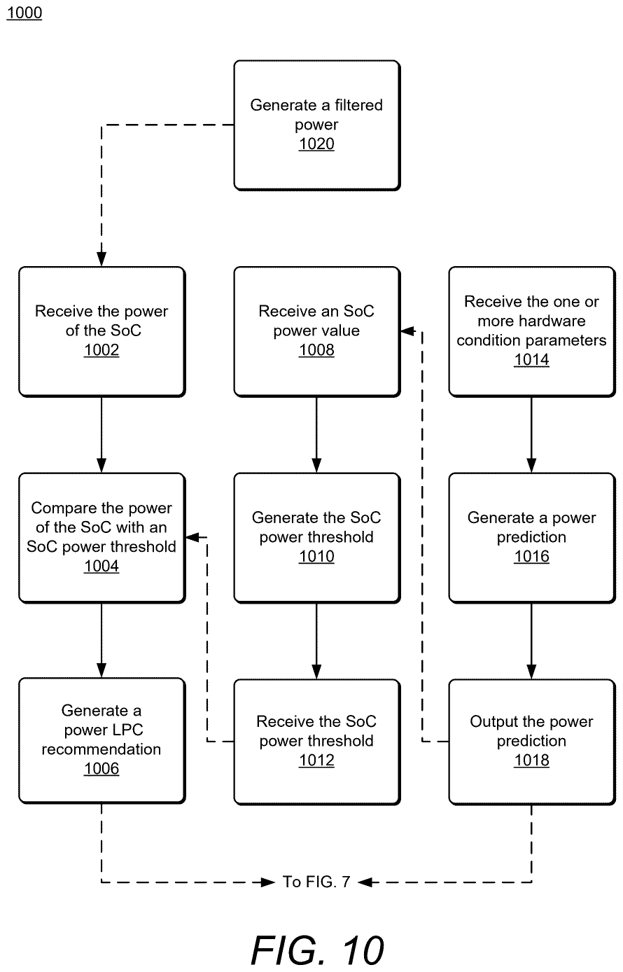

FIG. 10 illustrates the example method 1000 for configuring an LLM pipeline (e.g., the LLM pipeline 106 of FIG. 1). The method 1000 includes the method 700. At 1002, the power of the SoC (e.g., the hardware condition parameters 114 of FIG. 1) is received by the power monitor module (e.g., the power monitor module 406 of FIG. 4). At 1004, the power of the SoC is compared with an SoC power threshold (e.g., the SoC power threshold 518 of FIG. 5) by the power monitor module. At 1006, a power LPC recommendation (e.g., the power LPC recommendation 516 of FIG. 5) is generated by the power monitor module. In aspects, the power monitor module generates the power LPC recommendation based on the comparison of the power of the SoC to the SoC power threshold. The one or more LPC recommendations (e.g., the one or more LPC recommendations 302 of FIG. 3) may include the power LPC recommendation. In some examples, the power LPC recommendation is configured to disable a number of feedforward layers of the LLM pipeline, remove a subset of a context data from a cache of the LLM pipeline, or select a token generation algorithm from a plurality of token generation algorithms of the LLM pipeline.

At 1008, an SoC power value is received by a policy coordinator module (e.g., the policy coordinator module 508 of FIG. 5). The SoC power value may be based on the power of the SoC. At 1010, the SoC power threshold is generated by the policy coordinator module. At 1012, the SoC power threshold is received by the power monitor module. At 1014, the one or more hardware condition parameters is received by a prediction module (e.g., the prediction module 512 of FIG. 5). The prediction module may be a machine-learned model. At 1016, a power prediction (e.g., the prediction recommendations 514 of FIG. 5) is generated by the prediction module. At 1018, the power prediction is output to the policy coordinator module and to the decision module (e.g., the decision module 110 of FIG. 1). The SoC power value may include the power prediction, and the reconfigured LPC (e.g., the reconfigured LPC 502 of FIG. 5) may be based on the power prediction. At 1020, a filtered power of the SoC is generated by a filter by filtering the power of the SoC. In some examples, the filter is a lowpass filter. The power of the SoC received by the power monitor module may include the filtered power of the SoC.

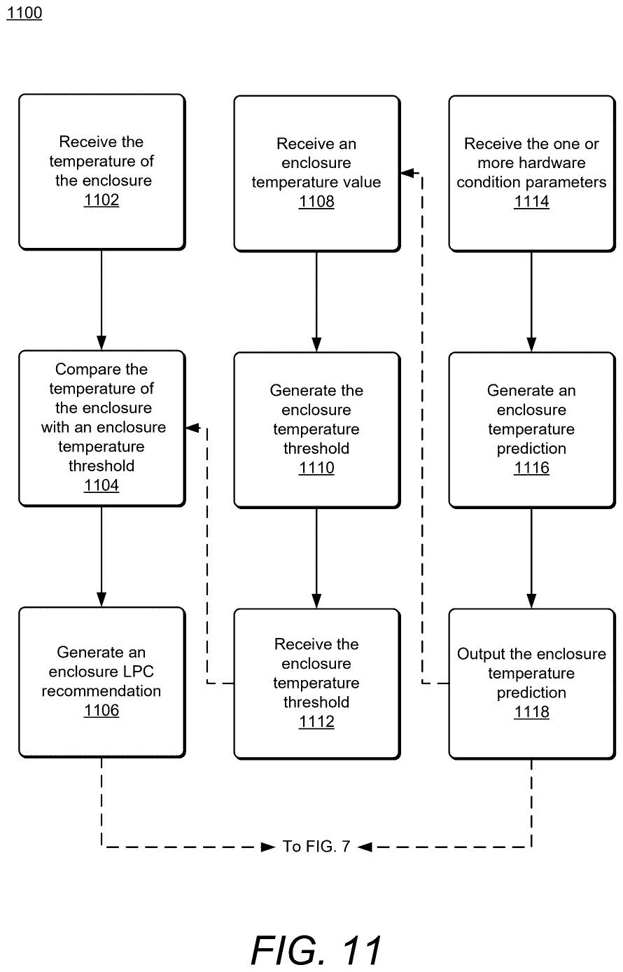

FIG. 11 illustrates the example method 1100 for configuring an LLM pipeline (e.g., the LLM pipeline 106 of FIG. 1). The method 1100 includes the method 700. At 1102, the temperature of the enclosure (e.g., the hardware condition parameters 114 of FIG. 1) is received by the enclosure monitor module (e.g., the enclosure monitor module 408 of FIG. 4). The enclosure may house at least the LLM pipeline. At 1104, the temperature of the enclosure is compared with an enclosure temperature threshold (e.g., the enclosure temperature threshold 522 of FIG. 5) by the enclosure monitor module. At 1106, an enclosure LPC recommendation (e.g., the enclosure LPC recommendation 520 of FIG. 5) is generated by the enclosure monitor module. In aspects, the enclosure monitor module generates the enclosure LPC recommendation based on the comparison of the temperature of the enclosure to the enclosure temperature threshold. The one or more LPC recommendations (e.g., the one or more LPC recommendations 302 of FIG. 3) may include the enclosure LPC recommendation. In some examples, the enclosure LPC recommendation is configured to select an LLM model of the LLM pipeline, direct a workload to a processor of a plurality of processors (e.g., the at least one processor 202 of FIG. 2) of the LLM pipeline, or reduce a pipeline prefix length of the LLM pipeline.

At 1108, an enclosure temperature value is received by a policy coordinator module (e.g., the policy coordinator module 508 of FIG. 5). The enclosure temperature value may be based on the temperature of the enclosure. At 1110, the enclosure temperature threshold is generated by the policy coordinator module. At 1112, the enclosure temperature threshold is received by the enclosure monitor module. At 1114, the one or more hardware condition parameters is received by a prediction module (e.g., the prediction module 512 of FIG. 5). The prediction module may be an ML model. At 1116, an enclosure temperature prediction (e.g., the prediction recommendations 514 of FIG. 5) is generated by the prediction module. At 1118, the enclosure temperature prediction is output to the policy coordinator module and to the decision module (e.g., the decision module 110 of FIG. 1). The enclosure temperature value may include the enclosure temperature prediction, and the reconfigured LPC (e.g., the reconfigured LPC 502 of FIG. 5) may be based on the enclosure temperature prediction.

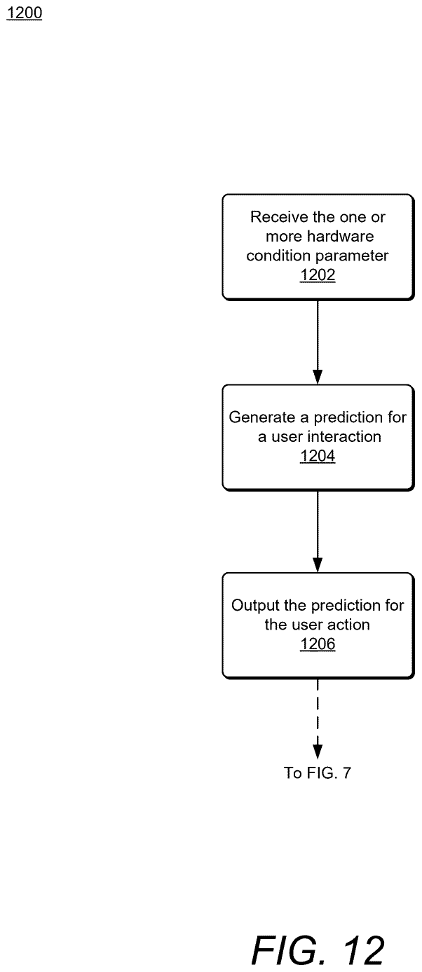

FIG. 12 illustrates the example method 1200 for configuring an LLM pipeline (e.g., the LLM pipeline 106 of FIG. 1). The method 1200 includes the method 700. At 1202, the one or more hardware condition parameters (the hardware condition parameters 114 of FIG. 1) is received by a prediction module (e.g., the prediction module 512 of FIG. 5). At 1204, a prediction for a user interaction (e.g., the prediction recommendations 514 of FIG. 5) is generated by the prediction module. In aspects, the prediction for the user interaction includes a likelihood value that a user will interact with the LLM pipeline. At 1206, the prediction for the user interaction is output to the decision module (e.g., the decision module 110 of FIG. 1). The reconfigured LPC (e.g., the reconfigured LPC 502 of FIG. 5) may be based on the prediction for the user interaction.

### ADDITIONAL EXAMPLES

Some additional examples are described below.

Example 1: A method for configuring a large language model (LLM) pipeline, the method including receiving, by a decision module, one or more hardware condition parameters. The method further includes receiving, by the decision module, one or more LLM pipeline configuration (LPC) recommendations and generating, by the decision module and based on the one or more hardware condition parameters and the one or more LPC recommendations, a reconfigured LPC. The method further includes reconfiguring, based on the reconfigured LPC, the LLM pipeline.

Example 2: The method of example 1, where the LLM pipeline includes one or more of an upper threshold for a number of matrix multiplications to be performed by the LLM, a model of the LLM, a token generation algorithm of the LLM, a prefix length for an input of the LLM, a low-rank adaptation (LoRA) selection, a number of layers of the LLM, an amount of access to a memory by the LLM, a frequency of one or more processors associated with the LLM, a voltage of the one or more processors associated with the LLM, or a number of cores of the one or more processors associated with the LLM.

Example 3: The method of any one of example 1 or 2, where the one or more LPC recommendations are generated by one or more process modules. The one or more process modules include one or more of a selective scaling module, a fast monitor module, a power monitor module, and an enclosure monitor module.

Example 4: The method of example 3, where the one or more process modules includes the selective scaling module. The method further including receiving, by the selective scaling module, one or more LLM parameters from the LLM pipeline and generating, by the selective scaling module and based on the one or more LLM parameters, a scaling LPC recommendation. The one or more LPC recommendations include the scaling LPC recommendation.

Example 5: The method of example 4, where the one or more LLM parameters include one or more of a latency of the LLM and a power consumption of the LLM.

Example 6: The method of example 3, where the one or more hardware condition parameters include a temperature of a system on chip (SoC) and the one or more process modules include the fast monitor module. The method further including receiving, by the fast monitor module, the temperature of the SoC. The method further includes comparing, by the fast monitor module, the temperature of the SoC with an SoC temperature threshold and generating, by the fast monitor module and based on the comparison of the temperature of the SoC to the SoC temperature threshold, a fast monitor LPC recommendation. The one or more LPC recommendations include the fast monitor LPC recommendation.

Example 7: The method of example 6, where the fast monitor LPC is configured to reduce a pipeline prefix length of the LLM pipeline, reduce a number of transformer layers of the LLM pipeline, set an upper threshold for a number of matrix multiplications to be performed by the LLM, reduce a numerical precision of the LLM, select a LorA for the LLM pipeline, or change an LLM model of the LLM pipeline.

Example 8: The method of example 6 or 7, further including receiving, by a policy coordinator module, an SoC temperature value based on the temperature of the SoC. The method further includes generating, by the policy coordinator module, the SoC temperature threshold and receiving, by the fast monitor module, the SoC temperature threshold.

Example 9: The method of example 8, further including receiving, by a prediction module, the one or more hardware condition parameters. The method further includes generating, by the prediction module, a temperature prediction and outputting the temperature prediction to the policy coordinator module and the decision module. The SoC temperature value includes the temperature prediction, and the reconfigured LPC is further based on the temperature prediction.

Example 10: The method of example 9, where the prediction model includes a machine-learned (ML) model.

Example 11: The method of example 3, where the one or more hardware condition parameters include a power of an SoC and the one or more process modules include the power monitor module. The method further including receiving, by the power monitor module, the power of the SoC, comparing, by the power monitor module, the power of the SoC with an SoC power threshold, and generating, by the power monitor module and based on the comparison of the power of the SoC to the SoC power threshold, a power LPC recommendation. The one or more LPC recommendations include the power LPC recommendation.

Example 12: The method of example 11, where the power LPC is configured to disable a number of feedforward layers of the LLM pipeline, remove a subset of a context data from a cache of the LLM pipeline, or select a token generation algorithm from a plurality of token generation algorithms of the LLM pipeline.

Example 13: The method of example 11 or 12, further including receiving, by a policy coordinator module, an SoC power value based on the power of the SoC. The method further includes generating, by the policy coordinator module, the SoC power threshold, and receiving, by the power monitor module, the SoC power threshold.

Example 14: The method of example 13, further including receiving, by a prediction module, the one or more hardware condition parameters, generating, by the prediction module, a power prediction, and outputting the power prediction to the power monitor module and the decision module. The SoC power value includes the power prediction, and the reconfigured LPC is further based on the power prediction.

Example 15: The method of example 14, where the prediction model includes a machine-learned (ML) model.

Example 16: The method of example 13, further including generating, by a filter, a filtered power of the SoC by filtering the power of the SoC, where the power of the SoC received by the power monitor module includes the filtered power of the SoC.

Example 17: The method of example 16, where the filtering, by the filter, of the power of the SoC is a low-pass filtering.

Example 18: The method of example 3, where the one or more hardware condition parameters include a temperature of an enclosure, the enclosure housing at least the LLM pipeline, and the one or more process modules include the enclosure monitor module. The method further including receiving, by the enclosure monitor module, the temperature of the enclosure, comparing, by the enclosure monitor module, the temperature of the enclosure with an enclosure temperature threshold, and generating, by the enclosure monitor module and based on the comparison of the temperature of the enclosure to the enclosure temperature threshold, an enclosure LPC recommendation. The one or more LPC recommendations include the enclosure LPC recommendation.

Example 19: The method of example 18, where the enclosure LPC is configured to select an LLM model of the LLM pipeline, direct a workload to a processor of a plurality of processors of the LLM pipeline, or reduce a pipeline prefix length of the LLM pipeline.

Example 20: The method of example 18 or 19, further including receiving, by a policy coordinator module, an enclosure temperature value based on the temperature of the enclosure, generating, by the policy coordinator module, the enclosure temperature threshold, and receiving, by the enclosure monitor module, the enclosure temperature threshold.

Example 21: The method of example 18, further including receiving, by a prediction module, the one or more hardware condition parameters, generating, by the prediction module, an enclosure temperature prediction, and outputting the enclosure temperature prediction to the power monitor module and the decision module. The enclosure temperature value includes the enclosure temperature prediction, and the reconfigured LPC is further based on the enclosure temperature prediction.

Example 22: The method of example 21, where the prediction model includes a machine-learned (ML) model.

Example 23: The method of example 1, further including receiving, by a prediction module, the one or more hardware condition parameters, generating, by the prediction module, a prediction for a user interaction, the prediction for the user interaction including a likelihood value that a user will interact with the LLM pipeline, and outputting the prediction for the user interaction to the decision module. The reconfigured LPC is further based on the prediction for the user interaction.

Example 24: An electronic device including an LLM pipeline including at least one LLM, one or more processors, one or more process modules, a prediction module, a filter, a policy coordinator module, and a memory storing instructions that, when accessed by the one or more processors, cause the one or more processors to perform the method of any one of examples 1-23.

Example 25: A non-transitory, computer-readable medium storing instructions that, when accessed by one or more processors, cause the one or more processors to perform the method of any one of examples 1-23.

Example 26: A computer programming product storing instructions that, when accessed by one or more processors, cause the one or more processors to perform the method of any one of examples 1-23.

### CONCLUSION

Although techniques using, and apparatuses including, an adaptive LLM architecture based on SoC temperature and power have been described in language specific to features and/or methods, it is to be understood that the subject of the appended claims is not necessarily limited to the specific features or methods described. Rather, the specific features and methods are disclosed as example implementations of an adaptive LLM architecture based on SoC temperature and power.

What is claimed is:

1. A method for configuring a large language model (LLM) pipeline, the method comprising:
receiving, by a decision module, one or more hardware condition parameters;
receiving, by the decision module, one or more LLM pipeline configuration (LPC) recommendations;
generating, by the decision module and based on the one or more hardware condition parameters and the one or more LPC recommendations, a reconfigured LPC; and
reconfiguring, based on the reconfigured LPC, the LLM pipeline.

2. The method of claim 1, wherein the LLM pipeline comprises one or more of:
an upper threshold for a number of matrix multiplications to be performed by the LLM;
a model of the LLM;
a token generation algorithm of the LLM;
a prefix length for an input of the LLM;
a low-rank adaptation (LoRA) selection;
a number of layers of the LLM;
an amount of access to a memory by the LLM;
a frequency of one or more processors associated with the LLM;
a voltage of the one or more processors associated with the LLM; or
a number of cores of the one or more processors associated with the LLM.

3. The method of claim 1, wherein the one or more LPC recommendations are generated by one or more process modules, the one or more process modules comprising one or more of:
a selective scaling module;
a fast monitor module;
a power monitor module; or
an enclosure monitor module.

4. The method of claim 3, wherein:
the one or more hardware condition parameters comprise a temperature of a system on chip (SoC); and
the one or more process modules comprise the fast monitor module, the method further comprising:
receiving, by the fast monitor module, the temperature of the SoC;
comparing, by the fast monitor module, the temperature of the SoC with an SoC temperature threshold; and
generating, by the fast monitor module and based on the comparison of the temperature of the SoC to the SoC temperature threshold, a fast monitor LPC recommendation, wherein the one or more LPC recommendations comprise the fast monitor LPC recommendation.

5. The method of claim 4, further comprising:
receiving, by a policy coordinator module, an SoC temperature value based on the temperature of the SoC;
generating, by the policy coordinator module, the SoC temperature threshold; and
receiving, by the fast monitor module, the SoC temperature threshold.

6. The method of claim 3, wherein:
the one or more hardware condition parameters comprise a power of an SoC; and
the one or more process modules comprise the power monitor module, the method further comprising:
receiving, by the power monitor module, the power of the SoC;
comparing, by the power monitor module, the power of the SoC with an SoC power threshold; and
generating, by the power monitor module and based on the comparison of the power of the SoC to the SoC power threshold, a power LPC recommendation, wherein the one or more LPC recommendations comprise the power LPC recommendation.

7. The method of claim 6, wherein the power LPC is configured to:
disable a number of feedforward layers of the LLM pipeline;
remove a subset of a context data from a cache of the LLM pipeline; or
select a token generation algorithm from a plurality of token generation algorithms of the LLM pipeline.

8. The method of claim 6, further comprising generating, by a filter, a filtered power of the SoC by filtering the power of the SoC, wherein the power of the SoC received by the power monitor module comprises the filtered power of the SoC.

9. The method of claim 8, wherein the filtering, by the filter, of the power of the SoC is a low-pass filtering.

10. The method of claim 3, wherein:
the one or more hardware condition parameters comprise a temperature of an enclosure, the enclosure housing at least the LLM pipeline; and
the one or more process modules comprise the enclosure monitor module, the method further comprising:
receiving, by the enclosure monitor module, the temperature of the enclosure;
comparing, by the enclosure monitor module, the temperature of the enclosure with an enclosure temperature threshold; and
generating, by the enclosure monitor module and based on the comparison of the temperature of the enclosure to the enclosure temperature threshold, an enclosure LPC recommendation, wherein the one or more LPC recommendations comprise the enclosure LPC recommendation.

11. The method of claim 1, further comprising:
receiving, by a prediction module, the one or more hardware condition parameters;
generating, by the prediction module, a prediction for a user interaction, the prediction for the user interaction comprising a likelihood value that a user will interact with the LLM pipeline; and
outputting the prediction for the user interaction to the decision module, wherein the reconfigured LPC is further based on the prediction for the user interaction.

12. An electronic device comprising:
an LLM pipeline including at least one LLM;
a decision module;
one or more processors; and
a memory storing instructions that, when accessed by the one or more processors, cause the one or more processors to:
receive, by the decision module, one or more hardware condition parameters;
receive, by the decision module, one or more LLM pipeline configuration (LPC) recommendations;
generate, by the decision module and based on the one or more hardware condition parameters and the one or more LPC recommendations, a reconfigured LPC; and
reconfigure, based on the reconfigured LPC, the LLM pipeline.

13. The electronic device of claim 12, wherein the LLM pipeline comprises one or more of:
an upper threshold for a number of matrix multiplications to be performed by the LLM;
a model of the LLM;
a token generation algorithm of the LLM;
a prefix length for an input of the LLM;
a low-rank adaptation (LoRA) selection;
a number of layers of the LLM;
an amount of access to a memory by the LLM;
a frequency of one or more processors associated with the LLM;
a voltage of the one or more processors associated with the LLM; or
a number of cores of the one or more processors associated with the LLM.

14. The electronic device of claim 12, further comprising one or more process modules, wherein the one or more LPC recommendations are generated by the one or more process modules, the one or more process modules comprising one or more of:
a selective scaling module;
a fast monitor module;
a power monitor module; or
an enclosure monitor module.

15. The electronic device of claim 14, wherein:
the one or more hardware condition parameters comprise a temperature of the one or more processors;
the one or more process modules comprise the fast monitor module; and
the instructions are further configured to cause the one or more processors to:
receive, by the fast monitor module, the temperature of the one or more processors;
compare, by the fast monitor module, the temperature of the one or more processors with a processor temperature threshold; and
generate, by the fast monitor module and based on the comparison of the temperature of the one or more processors to the processor temperature threshold, a fast monitor LPC recommendation, wherein the one or more LPC recommendations comprise the fast monitor LPC recommendation.

16. The electronic device of claim 15, further comprising a policy coordinator module, wherein the instructions are further configured to cause the one or more processors to:
receive, by the policy coordinator module, a processor temperature value based on the temperature of the one or more processors;
generate, by the policy coordinator module, the processor temperature threshold; and
receive, by the fast monitor module, the processor temperature threshold.

17. A non-transitory, computer-readable medium storing instructions that, when accessed by one or more processors, cause the one or more processors to:
receive, by a decision module, one or more hardware condition parameters;
receive, by the decision module, one or more LLM pipeline configuration (LPC) recommendations;
generate, by the decision module and based on the one or more hardware condition parameters and the one or more LPC recommendations, a reconfigured LPC; and
reconfigure, based on the reconfigured LPC, the LLM pipeline.

18. The non-transitory, computer-readable medium of claim 17, wherein the LLM pipeline comprises one or more of:
an upper threshold for a number of matrix multiplications to be performed by the LLM;
a model of the LLM;
a token generation algorithm of the LLM;
a prefix length for an input of the LLM;
a low-rank adaptation (LoRA) selection;
a number of layers of the LLM;
an amount of access to a memory by the LLM;
a frequency of one or more processors associated with the LLM;
a voltage of the one or more processors associated with the LLM; or
a number of cores of the one or more processors associated with the LLM.

19. The non-transitory, computer-readable medium of claim 17, wherein the one or more LPC recommendations are generated by one or more process modules, the one or more process modules comprising one or more of:
a selective scaling module;
a fast monitor module;
a power monitor module; or
an enclosure monitor module.

20. The non-transitory, computer-readable medium of claim 17, wherein the instructions further cause the one or more processors to:
receive, by a prediction module, the one or more hardware condition parameters;
generating, by the prediction module, a prediction for a user interaction, the prediction for the user interaction including a likelihood value that a user will interact with the LLM pipeline; and
output the prediction for the user interaction to the decision module, wherein the reconfigured LPC is further based on the prediction for the user interaction.
